(19) United States
(12) Patent Application Publication
(10) Pub. No.: US 2009/0111913 A1
(43) Pub. Date: Apr. 30, 2009

(54) Use of Polycarboxylate-Based Flow Agents for Anhydrite-Based Flow Screeds

(76) Inventors: Johann Plank, Munchen (DE); Dorina Vlad, Witten (DE)

Correspondence Address: FULBRIGHT & JAWORSKI, LLP, 666 FIFTH AVE, NEW YORK, NY, 10103-3198, US

(21) Appl. No.: 12/225,564

(22) PCT Filed: Mar. 27, 2007
(86) PCT No.: PCT/EP2007/002713

§ 371 Date: Oct. 22, 2008

(30) Foreign Application Priority Data
Mar. 29, 2006 (DE) 10 2006 014 529.1

(51) Int. Cl. C04B 24/28; C04B 111/62

(52) U.S. Cl. 524/5

(57) ABSTRACT

A plasticizer based on polycarboxylates is proposed, where the polycarboxylate component is a water-soluble, branched-chain and carboxyl-group-carrying copolymer which has at least one of the structural features selected from nitrogen-functionalized side chain and also, as linkage unit between main chain and side chain, an ester linkage, ether linkage and amide and/or imide linkage. The polycarboxylate component the molar ratio of acid groups to the side-group-carrying monomer is ≧2:1 and/or the side chain length n is <25, and the self-levelling screed has a sulphate content of ≧0.5% by weight, based on the total weight of the anhydrite fraction. The polycarboxylate component has a backbone provided with anionic functional groups and at least one non-ionic side chain has, preferably, an average molecular weight Mₙ between 5,000 and 250,000 g/mol. A particularly good liquefying effect is achieved here using a plasticiser in powder form, which is present in an amount of from 0.1 to 5% by weight, based on the content of mineral constituents in the self-levelling screed.

The present invention relates to the use of plasticiser based on polycarboxylates for anhydrite-based self-levelling screeds.

The addition of additives to hydraulic or latently hydraulic binders, for example cement or gypsum, is sufficiently known. An important group of additives is that of the plasticiser. By using them, and with the addition of water, a liquid binder slurry is obtained, through which overall the flowability is improved and thus the processability is facilitated. Examples of construction materials in which plasticiser are used to a great extent are self-levelling concrete and self-levelling screed. For example, in screed applications, about 5000 t of plasticiser are used worldwide per year, and in concrete applications in fact more than 500 000 t are used.

Anhydrite self-levelling screeds (ASSs) are screeds which are in most cases mixed by machine in varying mortar consistencies and, on account of their liquid consistency, pumped into the building structure, which is associated with a marked lightening of the work. Screeds of this type level largely automatically and/or they can be leveled with little work using a so-called buffing bar. Further advantages of ASSs are, inter alia, their high tensile strength in bending, a low tendency towards so-called curling, which is understood as meaning the shrinkage-induced bending of the screed slab at the edges, and also the possibility of laying large areas without joins. In practice, self-levelling screeds of this type are used in the form of wet and dry mortar systems. Wet mortars are supplied to the building site in a mixed form using concrete mixers, dry mortars are supplied to the building site in containers or in bags and only mixed once there.

In this connection, the binders used are primarily anhydrites. In the field of anhydrites, which are understood chemically as meaning CaSO₄, natural anhydrite, synthetic anhydrite and thermal anhydrite (so-called REA-anhydrite) are known. In contrast to gypsum, namely plaster of Paris (chemically CaSO₄.½H₂O), anhydrite sets only very slowly following the addition of water, i.e. in a time period which is not suitable in practice. Anhydrites therefore usually require so-called activators for accelerating the hydration. These consist either of alkali metal sulphates and in particular K₂SO₄ or of cements or CaO-releasing substances. The cements are typical alkaline activators, whereas the specified potassium sulphate is a type of salt-type activator. In practice, a mixed activation by sulphate and cements is often used.

Besides pure anhydrite, diverse mixtures of this binder type are used, such as, for example, anhydrite/calcined gypsum mixed systems with a fraction up to 50% by weight of calcined gypsum. The calcined gypsum can here be prepared from natural gypsum or REA gypsum, although usually α-semihydrate is used. Further anhydrite-based binder mixtures used are anhydrite/cement mixed systems, for which, however, a compromise has to be made between the low shrinkage values of the anhydrite and the water resistance of the cement. The cement fraction is therefore usually not more than one third of the overall amount of binder.

In the case of the plasticiser already discussed, in the area of anhydrite self-levelling screed melamine-formaldehyde-sulphite-based polycondensate resins are currently used in about 90% of cases of application. They are supplied with different molecular weights and varying molar ratios between the starting materials. The plasticiser used in each case can also be adapted in a targeted manner to the present type of anhydrite. To a lesser extent, β-naphthalenesulphonic acid-formaldehyde polycondensation products are also used. Although these are more cost-effective compared to the melamine-based plasticiser, they have a brown-yellow colour which, as a rule, leads to unattractive discolorations of the screed surface. This is one reason why the colourless melamine resins are used considerably more often.

However, these melamine resins also have disadvantages since—like the naphthalene plasticiser, they also have to be added in relatively high dosage amounts, namely in fractions between 0.3 and 0.7% by weight, based on the initial weight of additives, which adversely affects the economic feasibility of their use. Furthermore, they have considerable contents of free, i.e. chemically nonbonded formaldehyde, which is released over the course of time and thus pollutes the living space air.

The sulphates specified in connection with the activators only slightly adversely affect the liquefying effect of melamine and naphthalene resins, if at all. They are therefore the most reliable plasticiser for ASSs. If, however, polycarboxylate-based plasticiser, which have only been on the market for a few years, are used, very different effects are exhibited for identical products: whereas in the case of an ASS variant with polycarboxylate-based plasticiser, very good liquefying effects can be achieved even in an extremely low dosage of 0.05% by weight, with the identical plasticiser in another ASS, no adequate flow effect could be achieved even with very high and thus uneconomical dosage amounts of 1% by weight. For this reason, the polycarboxylate plasticiser, which have in the meantime become widespread in cement systems, have hitherto barely been used commercially in the ASS sector.

Polycarboxylates are polymers prepared by a free-radically initiated polymerization which have, as essential structural features, a main chain provided with anionic functional groups and a non-ionic side chain. On account of these structural features, which impart the appearance of a comb to the polymers, they are also referred to as comb or brush polymers.

In principle, four different polycarboxylate variants are known to date. These are firstly polymers which have ether linkages between the main chain and the side chain or chains. Preparation methods and areas of application for these polymers are known, for example, from the patent specifications DE 196 53 524 A1 and U.S. Pat. No. 6,176,921. Polycarboxylates of this type constitute the representatives used commercially by far the most often since they are accessible in particular extremely cost-effectively. Examples of a further polymer variant in which the main chain and the side chains are linked together by ester linkages can be found in DE 100 48 139 A1 and EP 0 610 699 A1. Overall, in practice, polycarboxylates with ester linkages outweigh those with ether linkages. The third variant has amide or imide bonds as linkage type between main chain and side chain. Finally, WO 00/39045 A1 describes polycarboxylates which have nitrogen functions in the side chain. However, this variant is only accessible with very high expenditure.

The use of polycarboxylates in the ASS sector has previously been described in DE 100 63 291 A1. Also known in this connection is the use of polycarboxylate plasticiser based on maleic anhydride or (meth)acrylic acid, malonic or (meth)acrylic acid esters or vinyl ethers. Compared to melamine resins, these plasticiser are characterized by a longer workability of the anhydrite-containing mass. The use of sulphatic activators is also disclosed, in which case in particular extremely low potassium sulphate contents of <0.8% by weight are stated. As a result of this amount of sulphate, which has deliberately been chosen to be low, the disadvantageous effects already discussed are suppressed, although it is to be noted that in practice predominantly ASS formations are used whose potassium sulphate contents are >1% by weight.

On account of the described disadvantages of the prior art, the object of the present invention was to provide new types of polycarboxylate-based plasticiser which, on account of their special structure and composition, reliably develop their liquefying effect even in sulphatically activated ASS irrespective of the type of anhydrite chosen and in particular also at the usual high concentrations of sulphatic activators. In particular, this should be possible with economically feasible use amounts and also the setting behaviour of the anhydrite should not be adversely affected in the form of a delay. Furthermore, it was desirable that these plasticiser are free from formaldehyde, as a result of which contamination of the room air in residential buildings can be excluded. To fulfil these conditions, plasticiser based on polycarboxylates are contemplated which are suitable for anhydrite-based self-levelling screeds. The polycarboxylate component is a water-soluble, branched-chain and carboxyl-group-carrying copolymer which has at least one of the structural features selected from the series nitrogen-functionalized side chain, and also, as linkage unit between main chain and side chain, an ester linkage, ether linkage and amide and/or imide linkage.

This object was achieved by the use of said plasticiser which, in a manner essential to the invention, are characterized in that

a) in the polycarboxylate component the molar ratio of acid groups to the side-group-carrying monomer is ≧2:1 and/or the side chain length n is <25, and

b) the self-levelling screed has a sulphate content of ≧0.5% by weight, based on the total weight of the anhydrite fraction.

Surprisingly, for the use according to the invention, it has been found that not only could the objective be completely met, where the plasticiser with the features essential to the invention develop their advantageous effect in highly diverse anhydrites and together with varying types of activator and concentrations. The liquefying effect through the polycarboxylate plasticiser is optimized here in particular through the low side-chain density coupled with high sulphate concentration. Thus, for example, it has been found that polycarboxylates with a molar ratio of methacrylic acid to MPEG ester of ≧3:1 remain completely effective with regard to their liquefying effect even in the presence of potassium sulphate. Polycarboxylates with a high anionic charge density in the backbone have been found to be particularly effective in sulphatically activated natural anhydrite. It was likewise surprising that polycarboxylate ethers with a relatively short side chain of e.g. 8.5 still exhibit a liquefying effect even in the case of a low methacrylic acid fraction. The large number of positive effects was not to be expected on the basis of the experiences made hitherto in sulphatically activated anhydrite-based self-levelling screeds.

The use of plasticiser in which the polycarboxylate component consists of a main chain provided with anionic functional groups and at least one non-ionic side chain has proven to be particularly advantageous.

With regard to the polycarboxylate component, the present invention considers in particular a variant in which the main chain carries at least one of the structural features

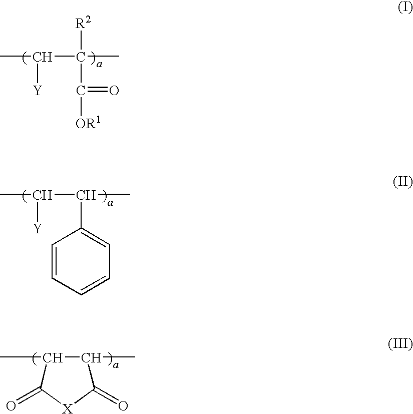

in which R¹═H, CH₃, NH₂, M or CH₂—CH₂—OₚCH₃
where M=mono- or divalent metal cation, in particular Na, or ammonium ion
R²═H or an aliphatic C₁₋₂₀-hydrocarbon radical
ₚ=5-150
X═O, NR³
where R³═H or a C₁₋₂₀ hydrocarbon radical optionally substituted by OH groups
Y═H, CH₃ or COOM_{c}
where c=½ or 1,

and, as linkage unit between main chain and side chain, at least one of the structural features

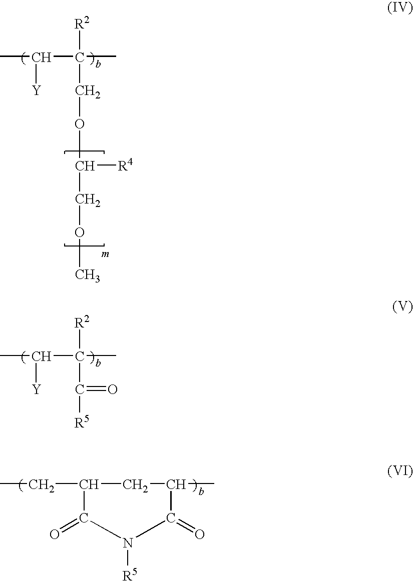

in which R² and Y have the stated meanings
R⁴=—H, —CH₃
R⁵=—NH—R⁶, R⁶ or —OCH₂—CH₂—O_{p′}CH₃—
where ₚ′=5-35 and

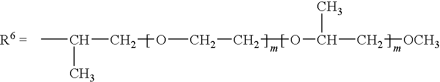

or R⁷
where R⁷=

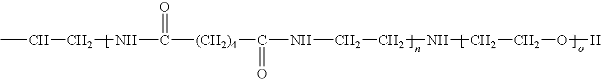

and

m=3 to 150

n=2 to 20

o=5 to 50 and

a and b, independently of one another, are ≦300, where

a:b 1 to 10:1.

Plasticiser of this type are previously described in particular in the already-cited German laid-open specification DE 100 63 291 which, with regard to the copolymers specified therein and the building groups contained therein, is an integral constituent of the present invention.

With regard to the anhydrite component, the invention envisages that this is a sulphatically and/or alkaline activated anhydrite which is preferably a natural anhydrite, a synthetic and chemical anhydrite and/or a thermal anhydrite. According to the invention, the self-levelling screed can comprise, besides the anhydrite component, also calcined gypsum, preferably in fractions up to 50% by weight, and/or a cement component, preferably in fractions up to 30% by weight.

It is to be regarded as essential to the invention that the self-levelling screed has a sulphate content of ≧0.5% by weight, based on the total weight of the anhydrite fraction. Since these high sulphate contents surprisingly do not adversely affect the liquefying effect of the plasticiser in the anhydrite-containing system, the present invention also includes sulphate contents of the self-levelling screed which are in fact ≧0.8% by weight and in particular ≧1.0% by weight, again in each case based on the total weight of the anhydrite fraction. As already discussed, the tolerance towards such high sulphate contents is surprising since usually the liquefying effect of polycarboxylates is impaired particularly by high sulphate activator concentrations.

The discussed sulphate content in the self-levelling screed should originate in particular to fractions of sulphates of alkali metals and subgroup metals, where iron sulphate, zinc sulphate, manganese sulphate and potassium sulphate are to be regarded as particularly preferred. In particular, the potassium sulphate can also be in the form of the double salt, such as, for example, syngenite (K₂SO₄.CaSO₄.H₂O). In this connection, it is of course also possible that the syngenite is formed only in the self-levelling screed composition.

Polycarboxylate components which have proven particularly suitable are those which have an average molecular weight Mₙ of from 5000 to 250 000 g/mol, with ranges between 15 000 and 150 000 and those between 30 000 and 100 000 g/mol being considered particularly preferred. In this connection, it is worth mentioning the fact that the individual side chains within a polycarboxylate molecule are naturally different from one another and in particular can have different lengths. For example, a polycarboxylate ether (PCE) molecule can be prepared from methacrylic acid and a mixture of MPEG esters where n_{EO}=25 and 90. However, a purely physical mixture of polycarboxylates with in each case different side chain (lengths) within one molecule or among one another is also possible.

From a practical processing point of view, the present invention also considers a plasticiser which can be used in powder form. This variant facilitates firstly transportation and storage, but also meterings since it can be added to the self-levelling screed adjusted to the particular ratios.

Finally, the present invention also considers that the plasticiser is used in the self-levelling screed in an amount of from 0.01 to 5% by weight, based on the content of mineral constituents.

In summary, it is established that the polycarboxylates used according to the invention ensure in particular a setting behaviour of the anhydrite fractions suitable for building sites in the self-levelling screeds. In particular, the otherwise customary negative effect of high sulphate activator amounts, which is attributable to a desorption of the polycarboxylate plasticiser due to the sulphate ions, is not observed in the case of the use according to the invention. This could be attributed to the fact that strongly anionic polycarboxylates cannot be desorbed from the anhydrite surface by sulphate ions and thus retain their effectiveness. The examples below illustrate these advantages of the present invention.

### EXAMPLES

Investigations with very many different anhydrites and various activator types and concentrations showed that the liquefying effect of polycarboxylates is adversely affected by high sulphate activator concentrations and only to a low extent by the cement activator. Further experiments showed that polycarboxylates with a high side-chain density (i.e. e.g. in the case of a molar ratio of methacrylic acid to MPEG methacrylate ester 1:1.5) are severely adversely affected by high sulphate contents of the anhydrite component. Conversely, polycarboxylates with a low side-chain density (e.g. molar ratio of methacrylic acid to MPEG methacrylate ester 3-6:1) still liquefy very well even at a high sulphate concentration (e.g. 1.2% by weight of K₂SO₄, based on anhydrite).

1. Table 1 shows experimental results with REA anhydrite. The liquefying effect was measured here with the help of the so-called degree of anhydrite spread. It is found that polycarboxylates with a molar ratio of methacrylic acid to MPEG ester of ≧3:1 remain completely effective even in the presence of relatively large amounts of K₂SO₄.

Table 1: Liquefying effect of polycarboxylates of varying composition in the anhydrite glue, measured by reference to the dosage required for a degree of spreading of 26±0.5 cm. (Blank value: 18±0.5 cm at a water/anhydrite ratio of 0.42).

| Example | Activator | Plasticiser dosage [% by wt.] | | |
|---|---|---|---|---|
| No. | [% by wt.] | MR* 1.5:1 | MR* 3:1 | MR* 6:1 |
| | Invention: | | | |
| | | Side chain length n_{EO} = 9 | | |
| 1 | CEM I 42.5 R | 0.3 | 0.2 | 0.2 |
| | [3% by wt.] | | | |
| | K₂SO₄ | | | |
| | [1.2% by wt.] | 0.75 | 0.3 | 0.2 |
| | | Side chain length n_{EO} = 17 | | |
| 2 | CEM I 42.5 R | 0.25 | 0.2 | 0.2 |
| | [3% by wt.] | | | |
| | K₂SO₄ | | | |
| | [1.2% by wt.] | 0.50 | 0.2 | 0.2 |
| | Comparison: | | | |
| | | Side chain length n_{EO} = 45 | | |
| 3 | CEM I 42.5 R | 1.0 | 0.15 | 0.13 |
| | [3.3% by wt.] | | | |
| | K₂SO₄ | | | |
| | [1.2% by wt.] | >2 | 0.25 | 0.1 |

*MR = Molar ratio methacrylic acid: methoxypolyethylene glycol methacrylate ester

2. Table 2 shows experimental results with sulphatically activated natural anhydrite (activator: 0.7% by wt K₂SO₄ and 3% by wt. CEM I

42.5 R. Blank value: 18±0.5 cm at a water/anhydrite ratio of 0.46).

| | | |
|---|---|---|
| Example | Polycarboxylate | Dosage for degree of spread |
| No. | composition | 26 ± 0.5 cm [% by wt.] |

Invention:

| | | |
|---|---|---|
| 4 | 8.5 PC 1.5 ¹⁾ | 0.2 |
| 5 | 8.5 PC 3 | 0.12 |
| 6 | 8.5 PC 6 | 0.10 |
| 7 | 17 PC 1.5 | 0.23 |
| 8 | 17 PC 3 | 0.09 |
| 9 | 17 PC 6 | 0.09 |
| 10 | 45 PC 1.5 | >1 |
| 11 | 45 PC 3 | 0.16 |
| 12 | 45 PC 6 | 0.09 |

Comparison:

| | | |
|---|---|---|
| 13 | Melment F15G ²⁾ | 0.4 |
| | Melment F17G ²⁾ | 0.5 |

¹⁾ 8.5 PC 1.5 means: 8.5 = number of ethylene oxide units in the side chain; 1.5 = molar ratio of methacrylic acid: MPEG ester
²⁾ Commercial products of Degussa Construction Polymers GmbH based on melamine-formaldehyde sulphite

Table 2 confirms that polycarboxylates with a high anionic charge density in the main chain (molar ratio of methacrylic acid: MPEG methacrylate ester ≧2) in sulphatically activated natural anhydrite are particularly effective. They liquefy at significantly more economical dosages than the melamine resins that are often currently used (comparative examples). Furthermore, it can be observed that PCE with short side chains (e.g. n_{EO}=8.5 and 17) exhibit good liquefying effect even in the case of a low methacrylic acid fraction.

3. Comparable results were also obtained with synthetic anhydrite from the production of hydrofluoric acid.

Table 3 shows results of the liquefying effect of polycarboxylates of varying composition in synthetic anhydrite, measured using the dosage required for a degree of spread of 26±0.5 cm (blank value: 18±0.5 cm at a water/anhydrite ratio of 0.45; activator: 1.2% by weight of syngenite; the anhydrite originated from the production of hydrofluoric acid (Fluorchemie Stulln)).

| Example | Polycarboxylate | Dosage for degree of spread |
|---|---|---|
| No. | Composition | 26 ± 0.5 cm [% by wt.] |
| 14 | 8.5 PC 1.5 ¹⁾ | 0.14 |
| 15 | 8.5 PC 3 | 0.087 |
| 16 | 8.5 PC 6 | 0.1 |
| 17 | 17 PC 1.5 | 0.13 |
| 18 | 17 PC 3 | 0.07 |
| 19 | 17 PC 6 | 0.09 |
| 20 | 45 PC 1.5 | 1.5 |
| 21 | 45 PC 3 | 0.1 |
| 22 | 45 PC 6 | 0.045 |

¹⁾ see Table 2

Heat calorimetric investigations show that the polycarboxylates according to the invention ensure a setting behaviour of the anhydrite which is suitable for building sites.

1-10. (canceled)

11. An anhydrite-based self-levelling screed comprising a flow agent based on a polycarboxylate and anhydrite, wherein the polycarboxylate component is a water-soluble, branched-chain and carboxyl-group-carrying copolymer which has at least one of the structural features selected from a nitrogen-functionalized side chain and a linkage unit between main chain and side chain that is selected from an ester linkage, an ether linkage, an amide linkage or an imide linkage; wherein the polycarboxylate component has at least one of a molar ratio of acid groups to the side-group-carrying monomer of ≧2:1 or a side chain length n of <25, wherein that the self-levelling screed has a sulfate content of ≧1.0% by weight, based on the total weight of the anhydrite fraction.

12. The anhydrite-based self-levelling screed of claim 11, wherein the polycarboxylate component consists of a main chain provided with anionic functional groups and at least one non-ionic side chain.

13. The anhydrite-based self-levelling screed of claim 11, wherein the polycarboxylate component in the main chain comprises at least one of the structural features 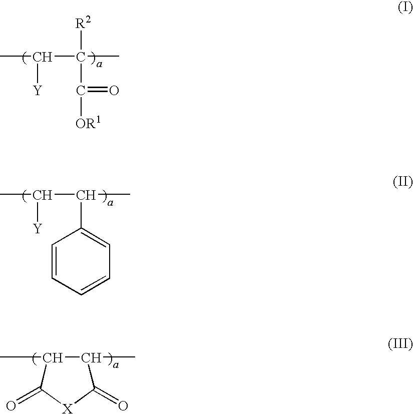
wherein R¹ is H, CH₃, NH₂, M or CH₂—CH₂—OₚCH₃;
wherein M is a mono- or di-valent metal cation;
R² is H or an aliphatic C₁₋₂₀-hydrocarbon radical;
ₚ is from 5 to 150;
X is O or NR³;
wherein R³ is H or a C₁₋₂₀ hydrocarbon radical which is optionally substituted with hydroxyl groups;
Y is H, CH₃ or COOM_{c}, wherein c is ½ or 1;
and, a linkage unit between the main chain and side chain selected from 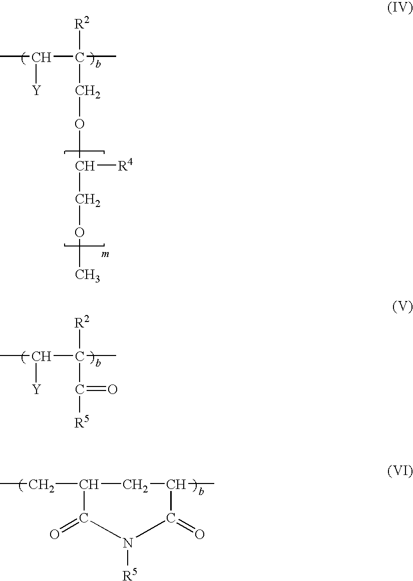
wherein R² and Y are as defined above;
R⁴ is —H or —CH₃
R⁵ is —NH—R⁶, R⁶ or —OCH₂—CH₂—O_{p′}CH₃
wherein ₚ′ is from 5 to 35; and 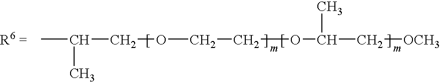
or R⁷
wherein R⁷ is 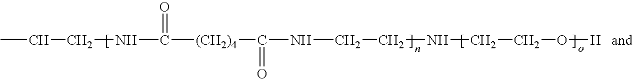
m is from 3 to 150
n is from 2 to 20
o is from 5 to 50 and
a and b are independently ≦300; and
wherein the ratio a:b is 1 to 10:1.

14. The anhydrite-based self-levelling screed of claim 11, wherein the anhydrite component is at least one of a sulphatically or alkaline activated anhydrite.

15. The anhydrite-based self-levelling screed of claim 11, wherein the self-levelling screed further comprises calcined gypsum.

16. The anhydrite-based self-levelling screed of claim 11, wherein the sulfate content is derived from comprises sulfates of alkali metal and subgroup metals.

17. The anhydrite-based self-levelling screed of claim 11, wherein the sulfate content is derived from iron sulphate, zinc sulphate, manganese sulphate, potassium sulphate and K₂SO₄.CaSO₄.H₂O.

18. The anhydrite-based self-levelling screed of claim 11, wherein the polycarboxylate component has an average molecular weight Mₙ of from 5,000 to 250,000 g/mol.

19. The anhydrite-based self-levelling screed of claim 11, wherein the flow agent is in powder form.

20. The anhydrite-based self-levelling screed of claim 11, wherein the flow agent is present in an amount of from 0.01 to 5% by weight, based on the content of mineral constituents in the self-levelling screed.

21. The anhydrite-based self-levelling screed of claim 13, wherein M is sodium or ammonium.

22. The anhydrite-based self-levelling screed of claim 21, wherein M is ammonium.

23. The anhydrite-based self-levelling screed of claim 21, wherein M is sodium.

24. The anhydrite-based self-levelling screed of claim 14, wherein the anhydrite component is a natural anhydrite, a synthetic a chemical anhydrite or a thermal anhydrite.

25. The anhydrite-based self-levelling screed of claim 15, wherein the calcined gypsum is present in a fraction of up to 50% by weight

26. The anhydrite-based self-levelling screed of claim 11, further comprising a cement component.

27. The anhydrite-based self-levelling screed of claim 26, wherein the cement component is present in an amount of up to 30% by weight.
